(19) United States
(12) Patent Application Publication
(10) Pub. No.: US 2002/0013734 A1
(43) Pub. Date: Jan. 31, 2002

(54) Universal internet smart delivery agent

(75) Inventor: Martin Gonzalo Bueno, Miami, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: E-FOOD.COM CORPORATION, MIAMI, FL (US)

(21) Appl. No.: 09/805,962

(22) Filed: Mar. 14, 2001

Related U.S. Application Data
(60) Provisional application No. 60/189,338, filed on Mar. 14, 2000.

(51) Int. Cl. G06F 17/60

(52) U.S. Cl. 705/26

(57) ABSTRACT

A computer implemented on-line system service manages an exchange between consumers and vendors located throughout different geographic locations. The on-line system service is particularly useful for a restaurant delivery and take-out environment. The on-line system service manages the exchange with databases that track menus from a variety of restaurants located in different geographic locations and profiles from a variety of consumers located in different geographic locations as well. Each menu is stored in a restaurant record that denotes the restaurant's city and neighborhood. The system is capable of searching on a plurality of keys in the menu records, to identify a menu record suitable for a particular consumer. The on-line service then facilitates the creation and editing of the new and existing menu records for the restauranteurs that include several categories such as menu item, item description, and price. A consumer selects a desired restaurant, desired items from the restaurant, and either restaurant take-out or delivery. The on-line system service generates an automatic order that is transmitted to the restaurant. The restaurant receives the automatic order and processes it accordingly.

### Cross-Reference To Related Applications

This application is based upon and claims priority from prior U.S. patent application Ser. No. 60/189,338 filed on Mar. 14, 2000, the entire disclosure of which is herein incorporated by reference.

### Background of the Invention

1. Field of the Invention

The present invention generally relates to the field of Internet web-based implemented systems for the posting of products and services by vendors, and the acceptance of orders for such products and services from consumers in response to such postings, and more particularly relates to a web-based system for posting menus and recording profiles from a variety of restaurants in a geographic location and receive orders from consumers in the geographic location. The on-line service may advantageously be accessible within a network, such as a local area network (LAN), a wide area network (WAN), a wireless application network, a wireless application device, or the Internet, in order to permit on-line access to a restaurant database through a region locator.

2. Description of the Prior Art

The Internet is a worldwide system of connected computer networks through a protocol named TCP-IP. The Internet enables computers, handheld devices and intelligent cellular phones and wireless communicators to share services and to communicate directly, as if they were part of one giant global computing machine. The Internet is currently configured to join together large commercial communication services, as well as thousands of corporate computer networks, universities and web site related with the selling of goods or services. Communication over the Internet is accomplished by defined communication protocols. Such communication may be interactive and is referred to as on-line service or interactive communication.

There are currently on-line food services, which are accessible through the world wide web. For example, www.food.com has on-line restaurant menus and users can browse, select their desired restaurant and place their order. There have been numerous other web sites related with food services. Those web sites generally post restaurant menus with different items and they send the requests or orders from the users to the restaurants via fax. There has not been a viable comprehensive system for managing on-line menus through the Internet, with effective editing capabilities for the restaurateurs, nor has there been a secured transactional environment that ensures a validated order from the user to the restaurant; in addition, the restaurateurs have not been able to verify the amount of orders that are being accepted during a specific time of day, is in accordance with their own defined delivery cycle requirements.

No other on-line food service contains operating hours that ensure to both restaurateurs and users that orders are being placed, will first be verified against the hours of operation profile and then reliably transmitted to the restauranteur, such as via reliable delivery wireless communication to the communication receiver of a corresponding restaurant. No other on-line food service contains pricing parameters indicating dollar minimums and maximums, ensuring that the orders match the restaurant's set policies, to deliver through that system.

No other on-line food service operating system has the ability to verify orders with a timely and accurate approach, as well as not having the ability to transmit orders via reliable wireless transmission. Unfortunately, traditional restaurateurs that provide delivery services and take-out to consumers have been using incoming phone calls, faxes or media printing that they distribute around the neighborhood to receive orders, and in that way they have not been able to supply the tools to consumers that are necessary for convenient, efficient, and cost effective, methods of ordering a variety of foods and services in the increasingly competitive environment of retail food services.

Accordingly, there exists a need for overcoming the disadvantages of the prior art as discussed above.

### SUMMARY OF THE INVENTION

According to an aspect of the present invention, an on-line service is implemented for the submission and location of restaurant menus through a restaurant database. A preferred embodiment of the present invention provides an on-line menu management system and an on-line menu submission system. A computer on-line implemented service, according to the preferred embodiment, assists in the delivery of food and services to a consumer end user. The computer-implemented service preferably links background information, in electronically readable memory, concerning restaurant profiles and descriptions also stored in memory. A search engine restaurant locator, in the preferred embodiment, locates restaurants vendors through a neighborhood specific location scheme. The on-line service facilitates the creation of member records with specific profiles, regardless of geographic location. A preferred embodiment provides interactive menus associated with restaurants and vendors and in which validated members can select menu items and place their orders and ensure that their orders will be delivered within timely and accurate parameters, based on a predefined restaurant profile in the system. In accordance with a preferred embodiment of the present invention, an on-line service provides an on-line application to define countries in which the on-line service is accepting requests from the members and in addition, each country will have their own defined parameters associated with that same country, including states within the country, cities within the states and neighborhoods within the cities. Additionally, the system will allow for each country to define additional parameters related with the country's currency and food categories, credit card acceptance standards, delivery policies, associated licenses and prices or percentages per transaction.

The invention may be implemented in a computer environment whose actions are directed by a computer program configured as a multiple relational database information system. The system includes a first database stored in electronically readable memory called “member database”, a second database stored in electronically readable memory called “vendor database”, a third database stored in electronically readable memory called a “transactional database”, and fourth database stored in electronically readable memory called “configuration database”. The system also includes a communication port (e.g., a network interface) suitable for transmitting and receiving electrical signals, to and from remote computers or hand held wireless devices and a database manager for creating and editing records of the four databases.

Members existing in the “member database” can search different restaurants through the “vendor database” in an environment set by the “configuration database” and orders can be made and registered through the “transactional database”. A consumer that is not validated in the “member database” can still search the “vendor database”, but the system will not allow that consumer to place an order for security purposes.

In an alternative preferred embodiment, an accounting and transactional system for clearing all transactions related with the orders received by the restaurants may also be provided and linked to merchant account systems.

Traditional restaurateurs that provide delivery services and take-out to consumers are using incoming phone calls, faxes or media printing that they distribute around the neighborhood to receive orders, and in that way they don't supply the tools to the consumers that are necessary in ordering a variety of food and services in an increasingly competitive environment driven by technological advances of communication and the, Internet.

The computers and the hand held devices connected to the Internet, for example, provide a new way of using a service, which permits rapid response and easy interaction from vendors. An on-line service, according to a preferred embodiment of the present invention, guides a consumer through certain steps and parameters to qualify a restaurant search by location, restaurant name, and category of food, price and menu items. According to the invention, restaurants that have on-line menus may be identified by a collection of parameters, which may be used to effectively allow narrow searching, and location of suitable restaurants, even in an extremely large restaurant database. The restaurant database includes parameters, which permits a member of the on-line service to search different kinds of services provided by the restaurant such as delivery, take-out and advance reservations. Establishing certain parameters such as kinds of food, services or restaurant locations, permits narrowing an extremely huge database to a more manageable size. When a restaurant menu is selected by a member, they can place an on-line order choosing different items that the restaurant offers, the on-line service will generate an order form that includes the items selected by the member, and send that information to the restaurant through the Internet or via an e-mail message sent to the specified recipient that appears in the restaurant profile that is stored in the “vendor database”. Once the member places an order, they can save that order and use it in a recurrent way, revising a historical transaction that they placed before or see a balance of their transactions between specific dates.

### BRIEF DESCRIPTION OF THE DRAWINGS

A clearer understanding of the present invention will be gained on studying the detailed description of preferred embodiments given by way of non-limiting examples and illustrated by the appended drawings, in which:

FIG. 1 is a schematic of an exemplary system architecture according to a preferred embodiment of the present invention. As shown in the schematic, the system can be implemented using general-purpose computer hardware as a host server application connected to the Internet. The general purposes hardware may be in the form of an NT or Unix system server or other suitable computer system. The hardware will be configured by various software models.

FIG. 1-A1 shows a computer or a handheld device that are connected to the Internet via cable, telephone lines, or via wireless connection. These computers represent the member or consumer device that they used to access the vendor database through a host application server.

FIG. 1-A2 shows an exemplary computer or a handheld device that are connected to the Internet via cable, telephone lines, or via wireless connected link. These computers represent the vendor communication device that they use to receive the orders that come from the member or consumers via a host application server.

FIG. 1-A3 shows the exemplary four databases structure in which the application server works to store and retrieve information related with the transaction requests by members or consumers.

FIG. 1-A4 shows an exemplary hardware device (Host Server) connected to the Internet that is running the four applications that interact directly with all four databases.

FIG. 2 is a software functional block diagram showing exemplary software models of four applications that may be utilized in the system of FIG. 1, according to a preferred embodiment of the present invention.

FIGS. 3 to 28 constitute a series of screen views of an exemplary user interface for an on-line computer system operating according to a preferred embodiment of the present invention.

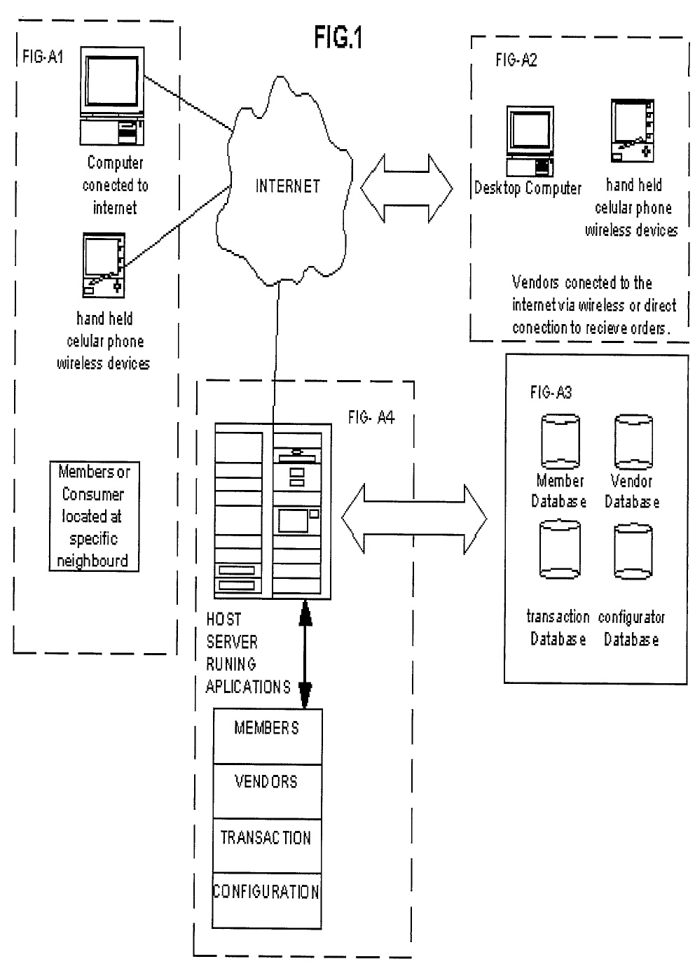

### DESCRIPTION OF THE PREFERRED EMBODIMENT

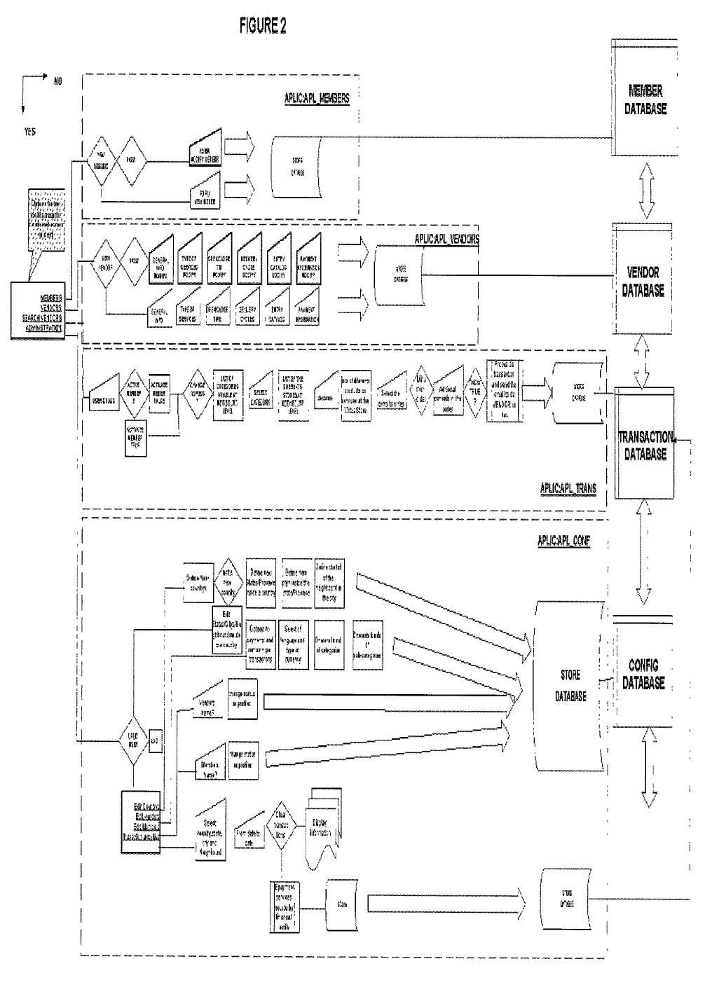

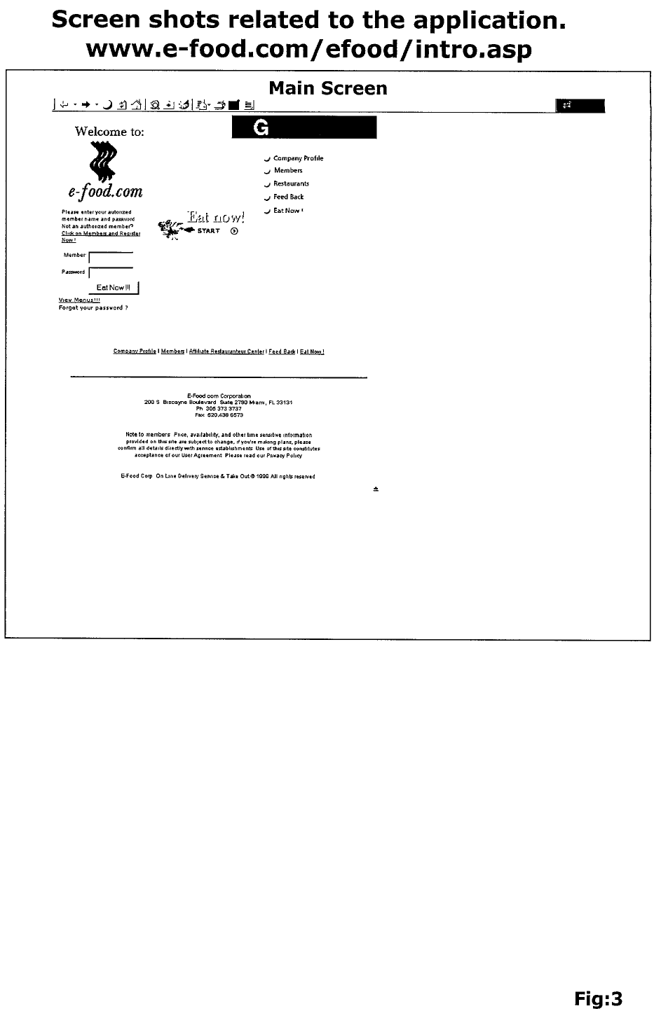

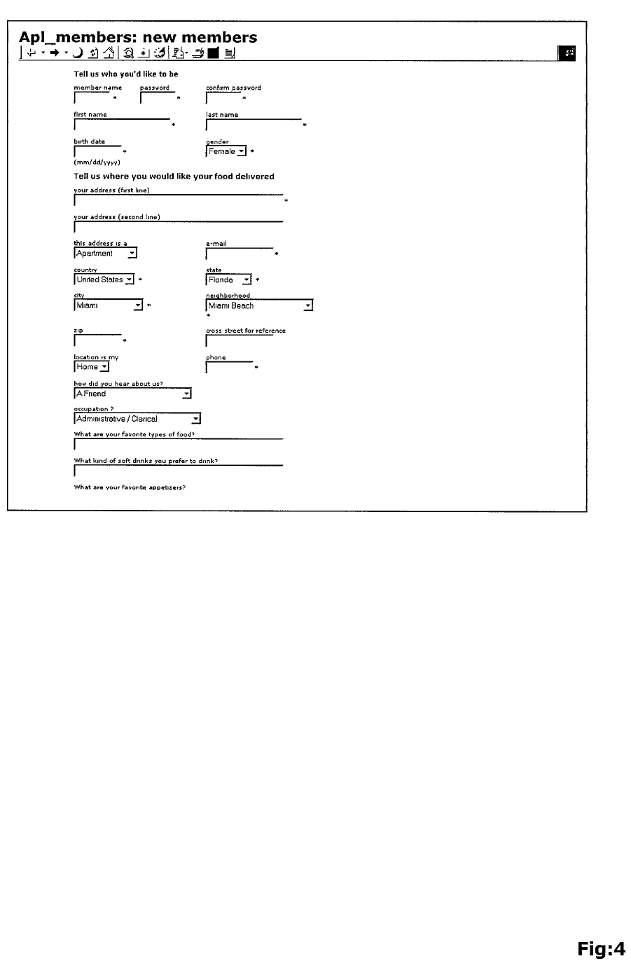

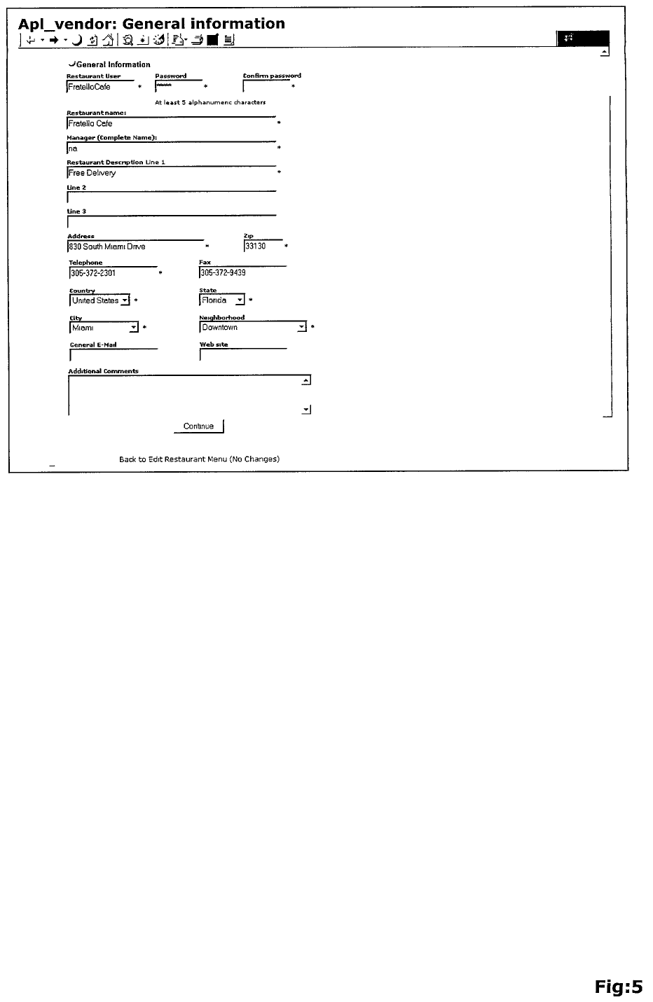

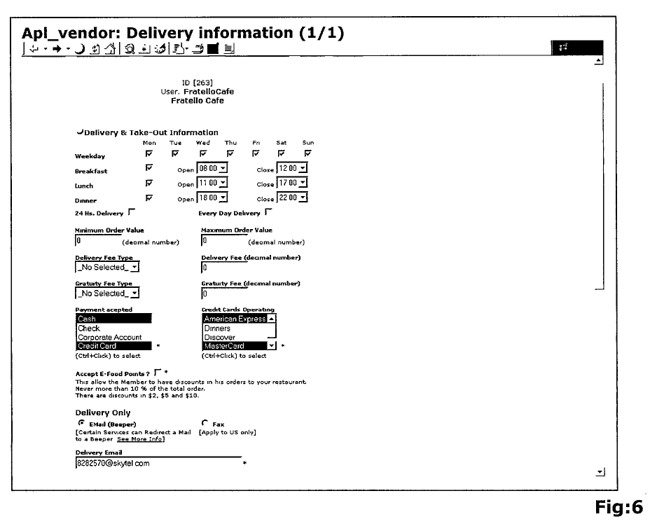

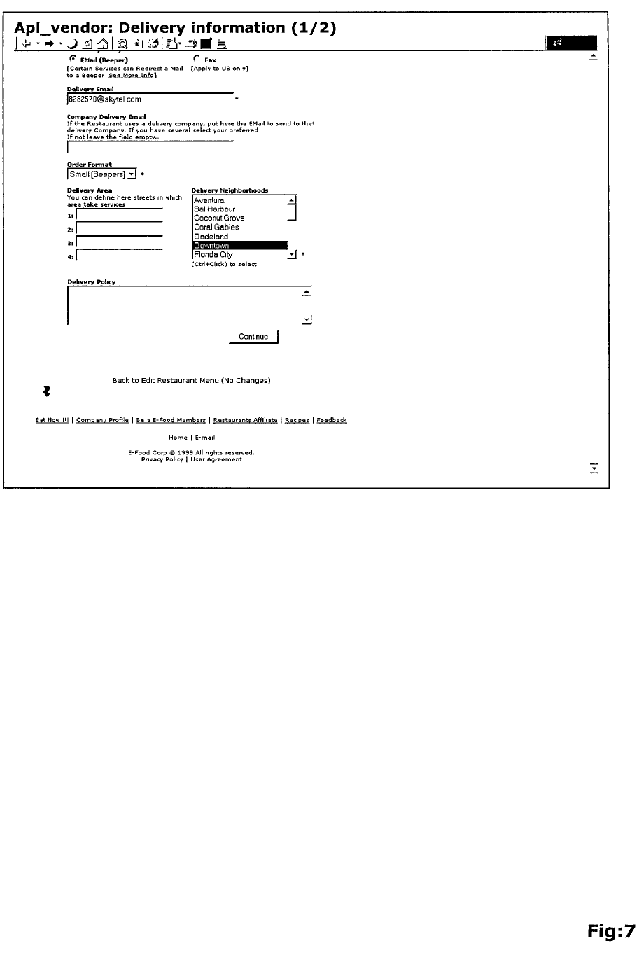

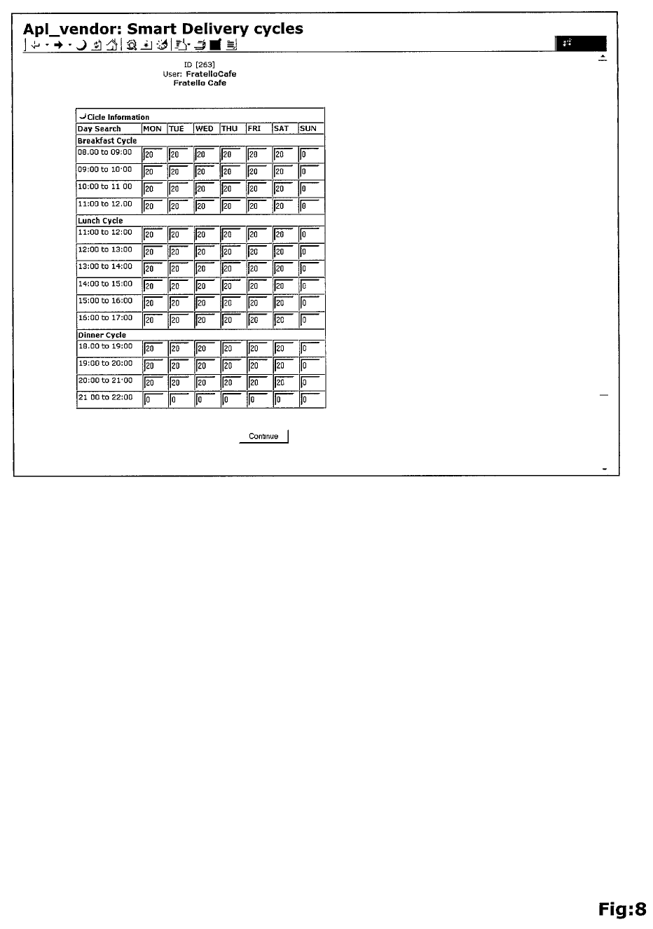

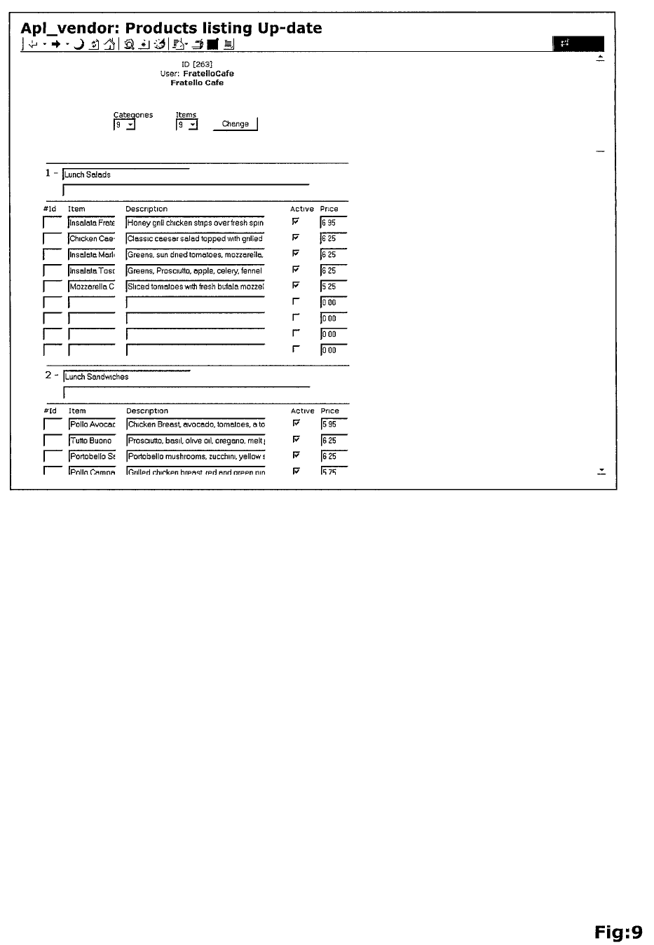

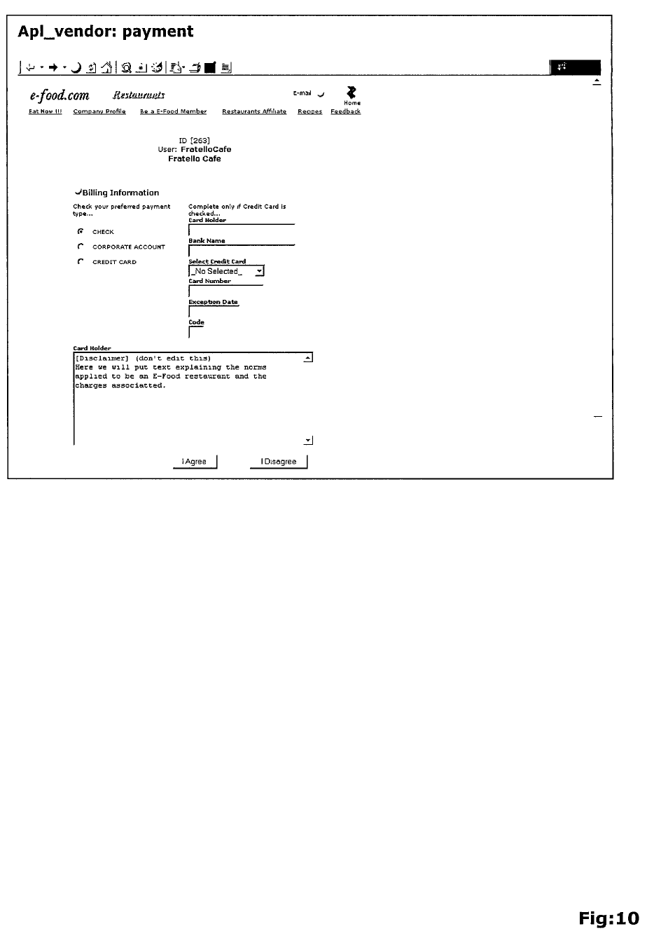

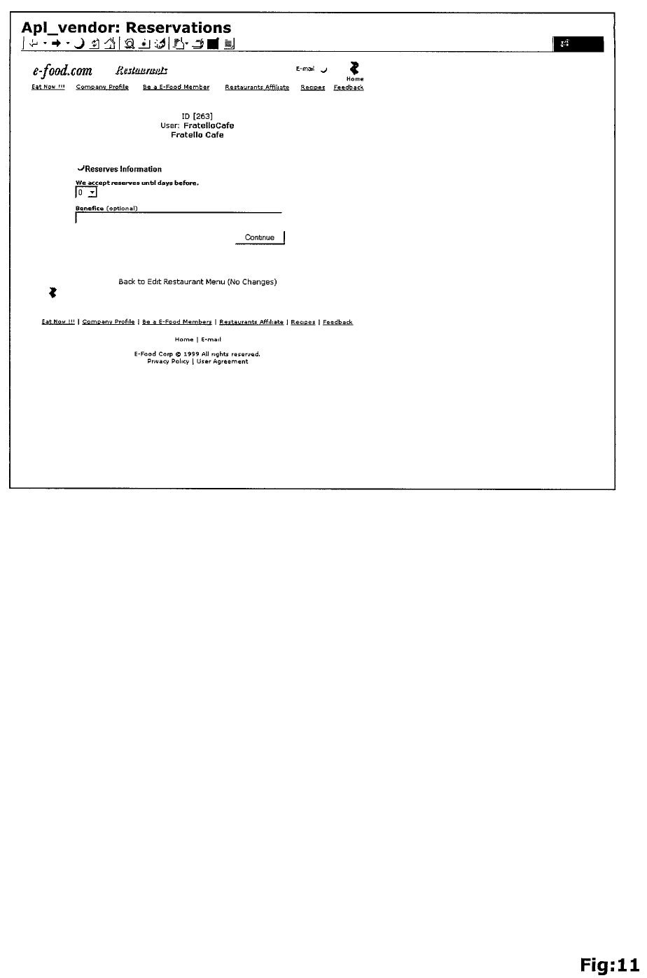

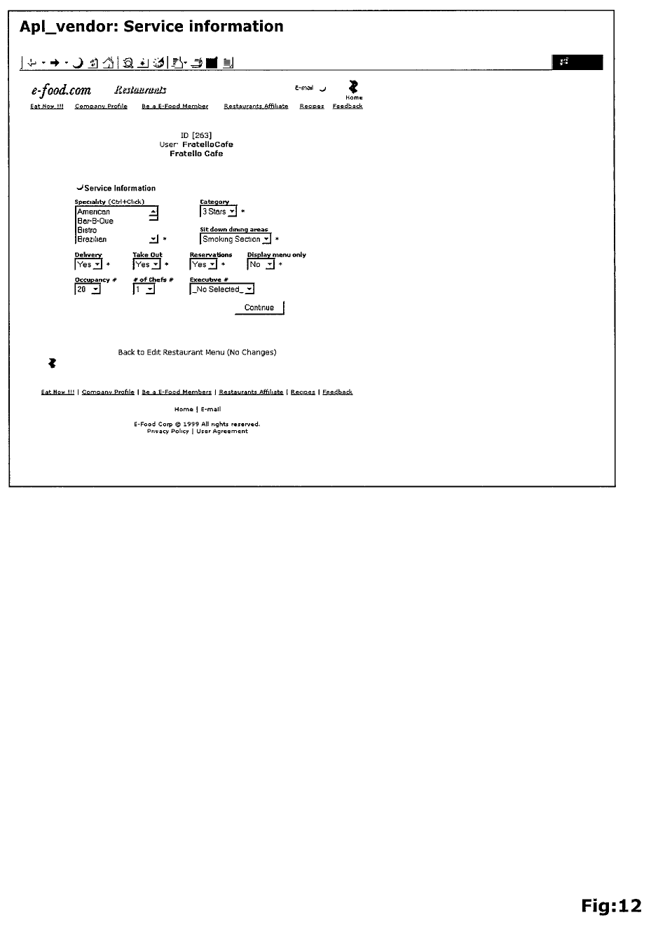

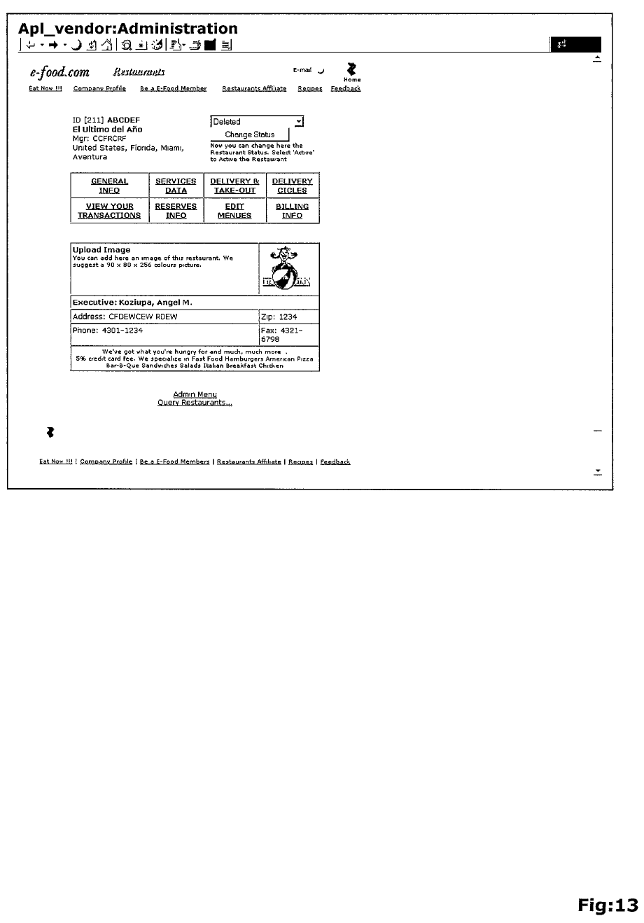

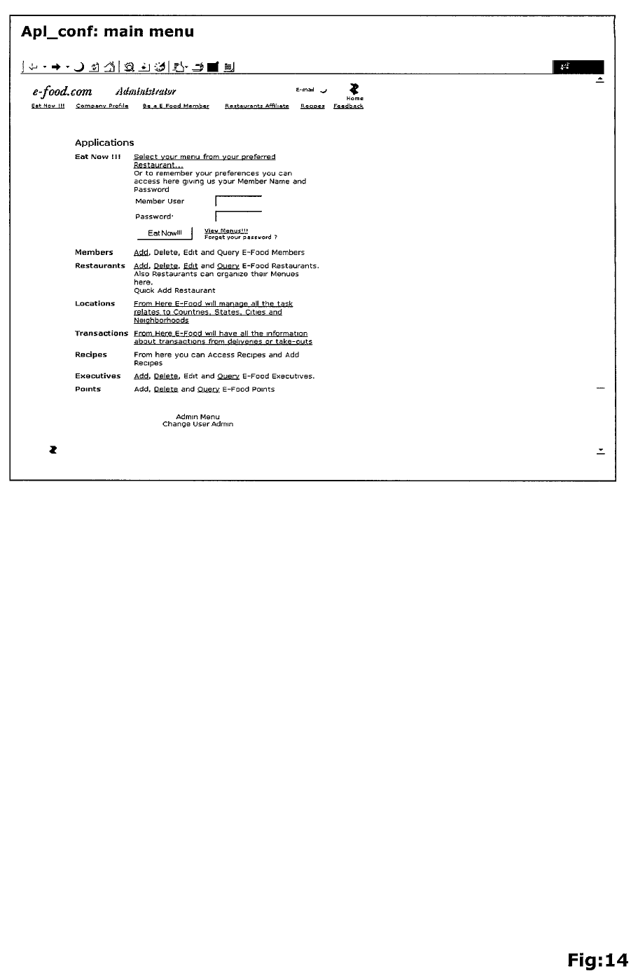

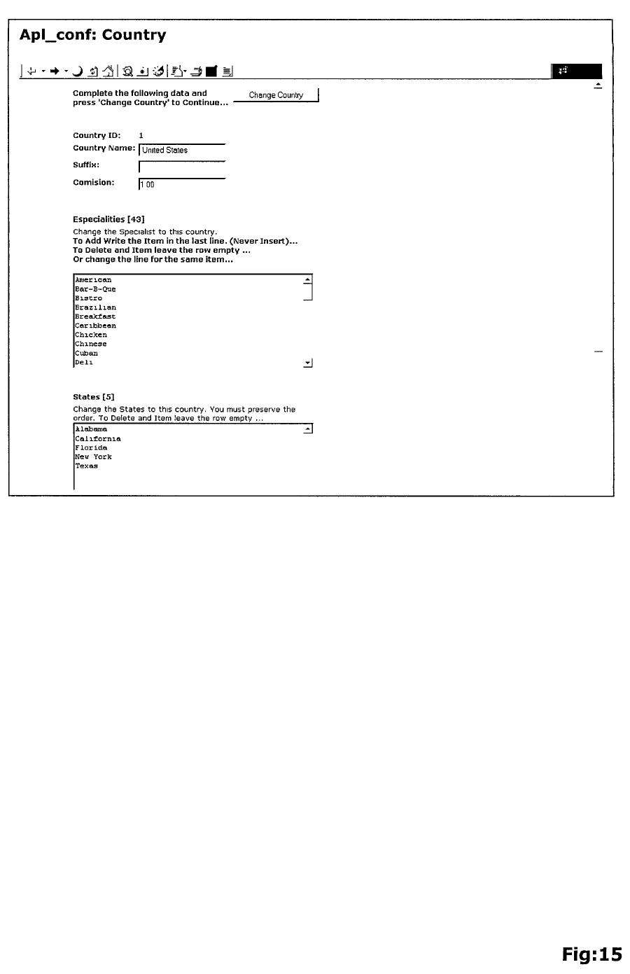

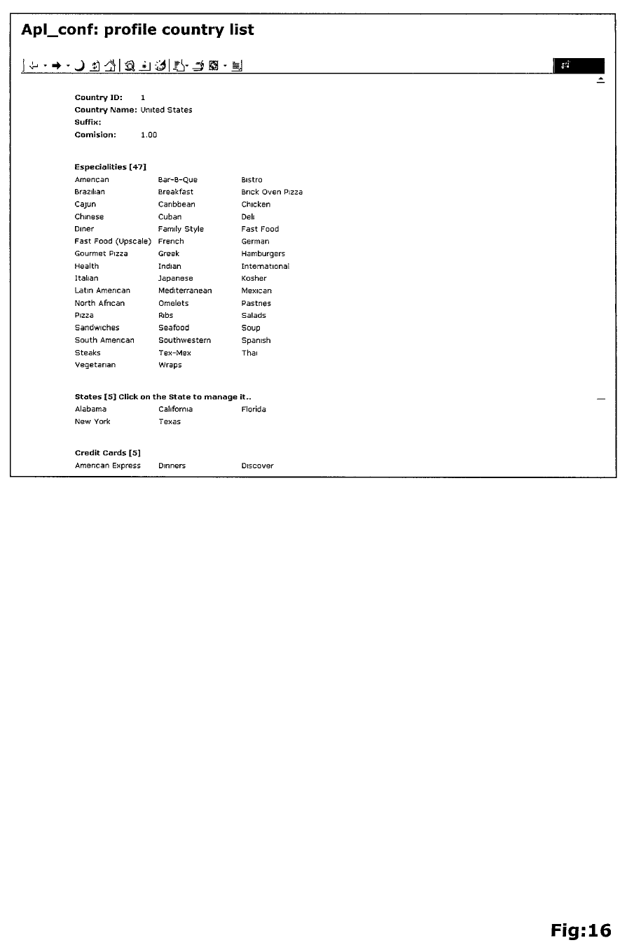

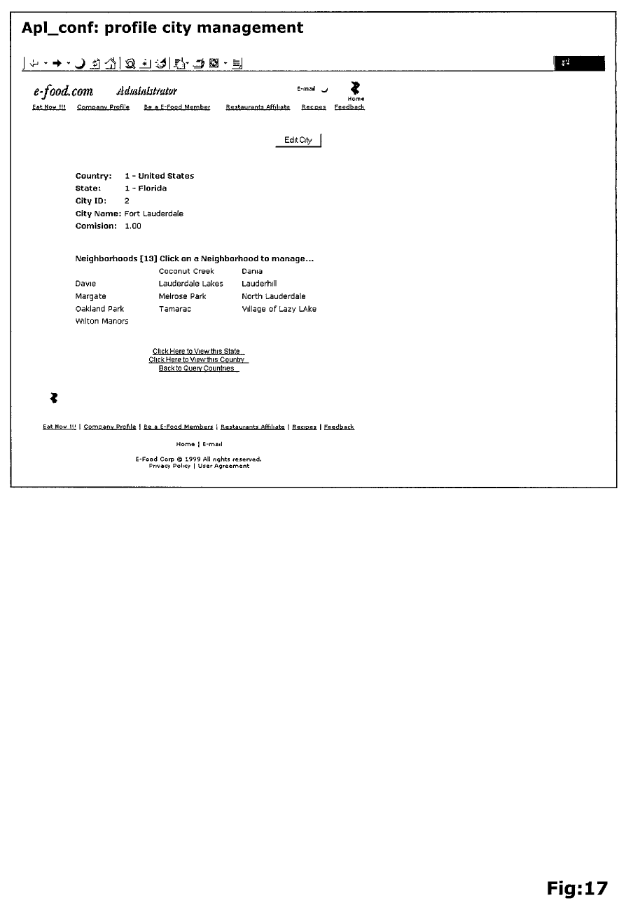

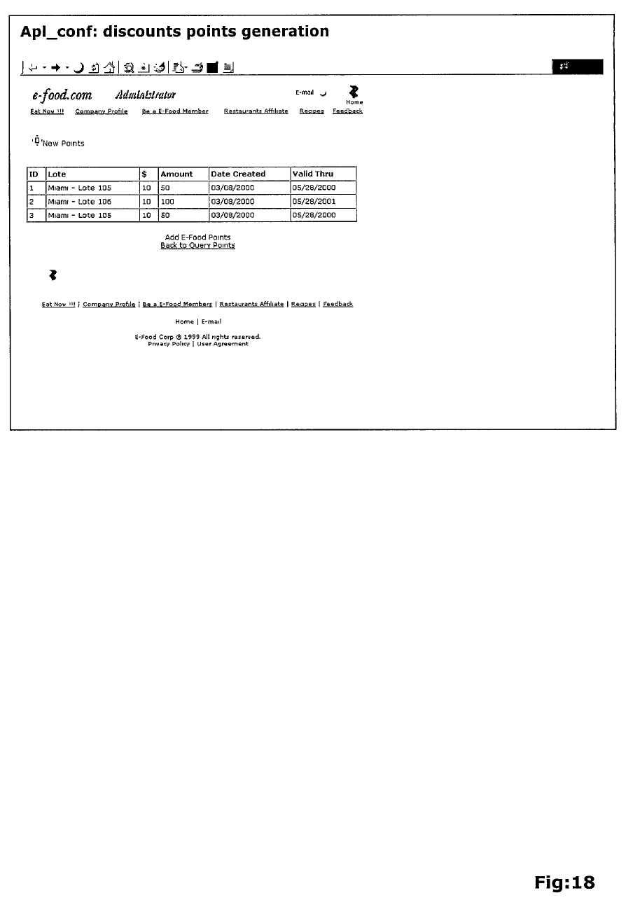

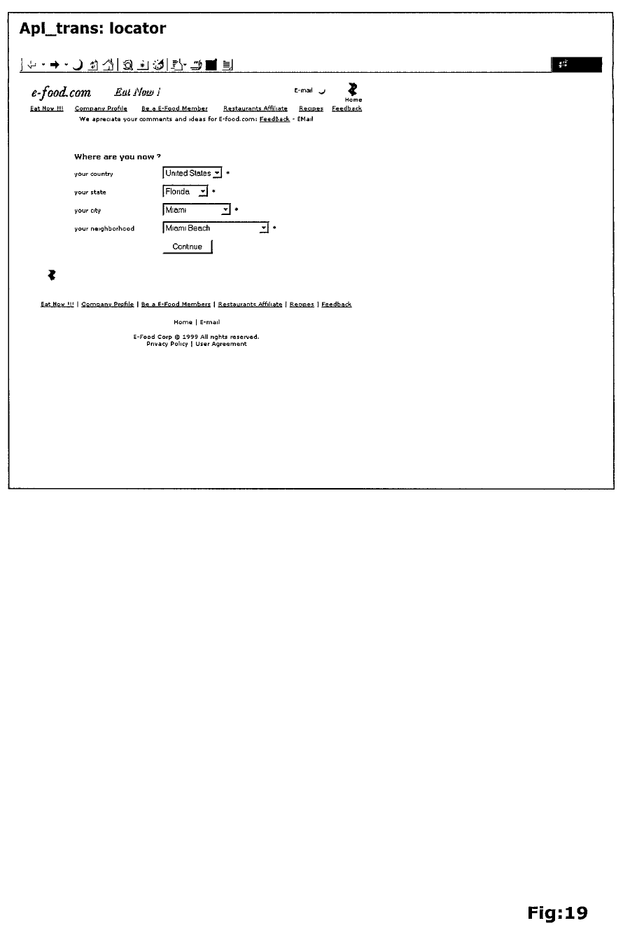

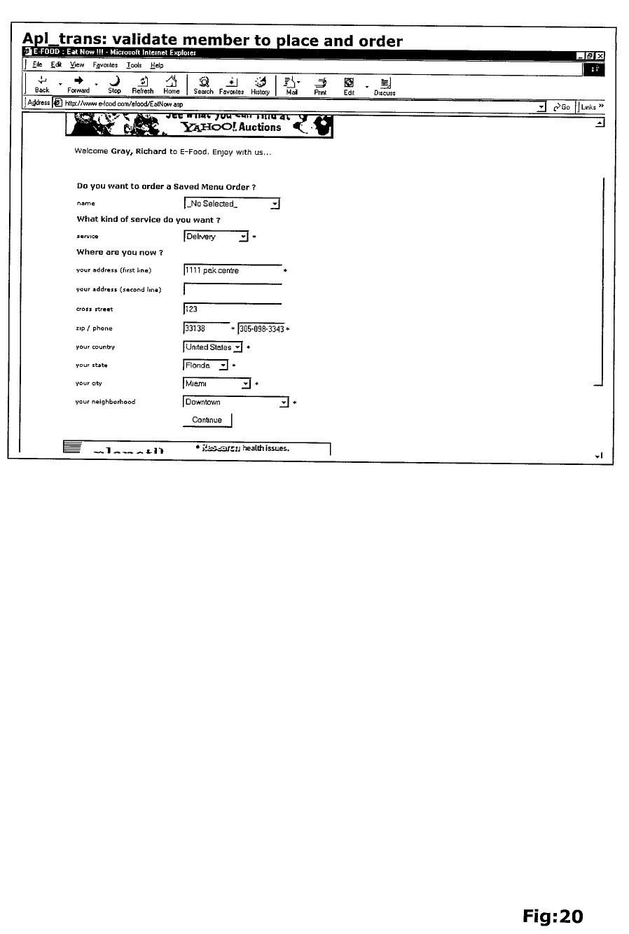

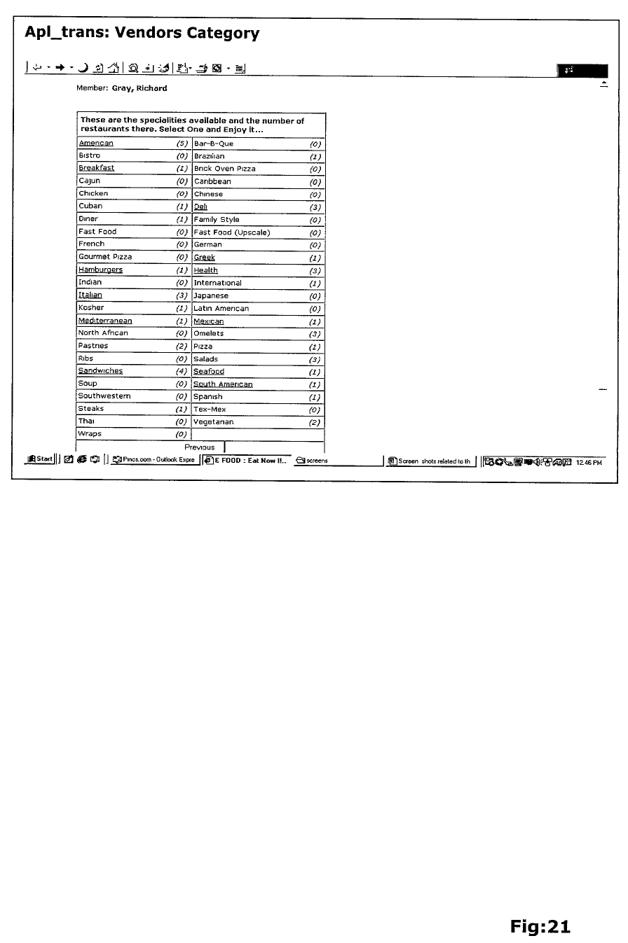

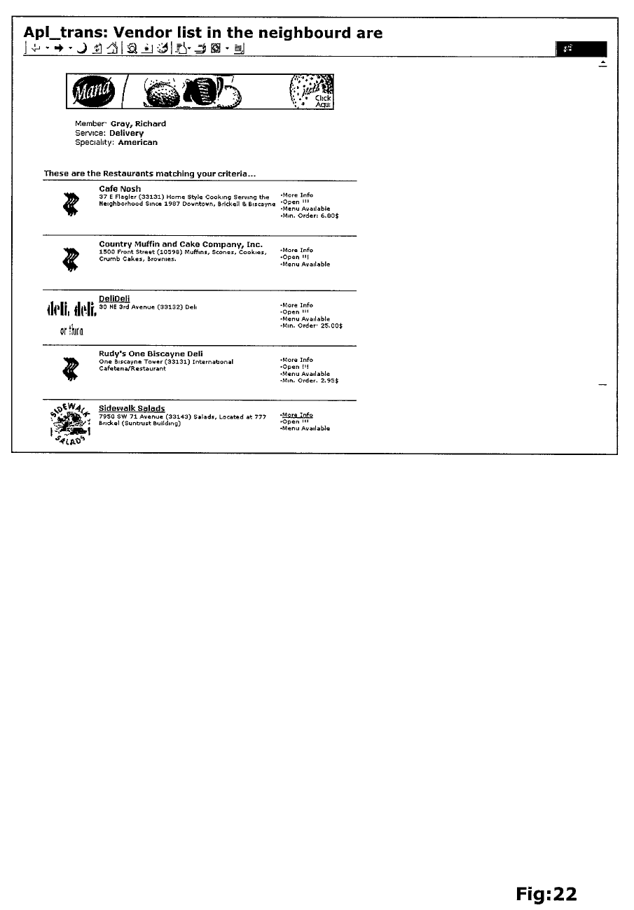

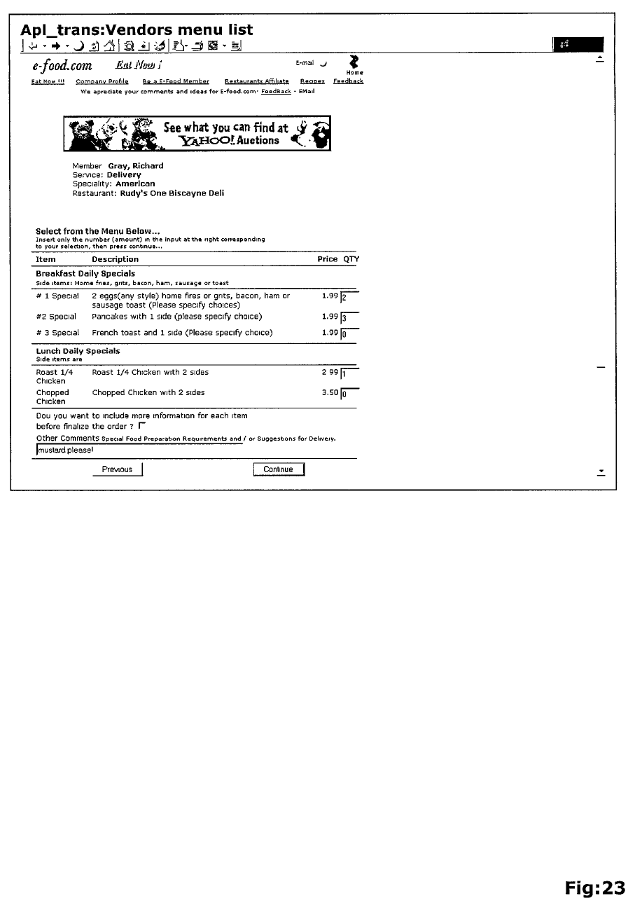

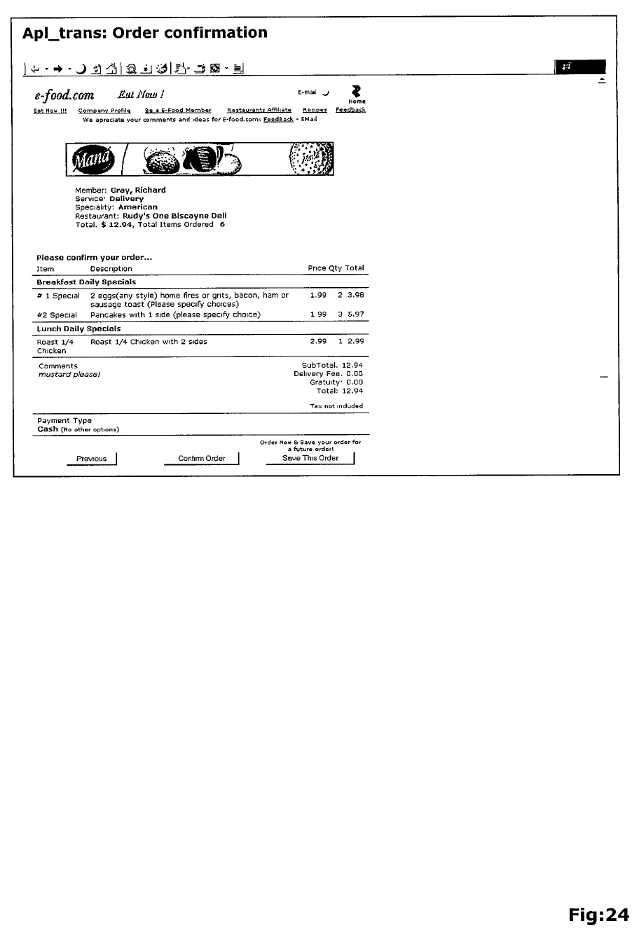

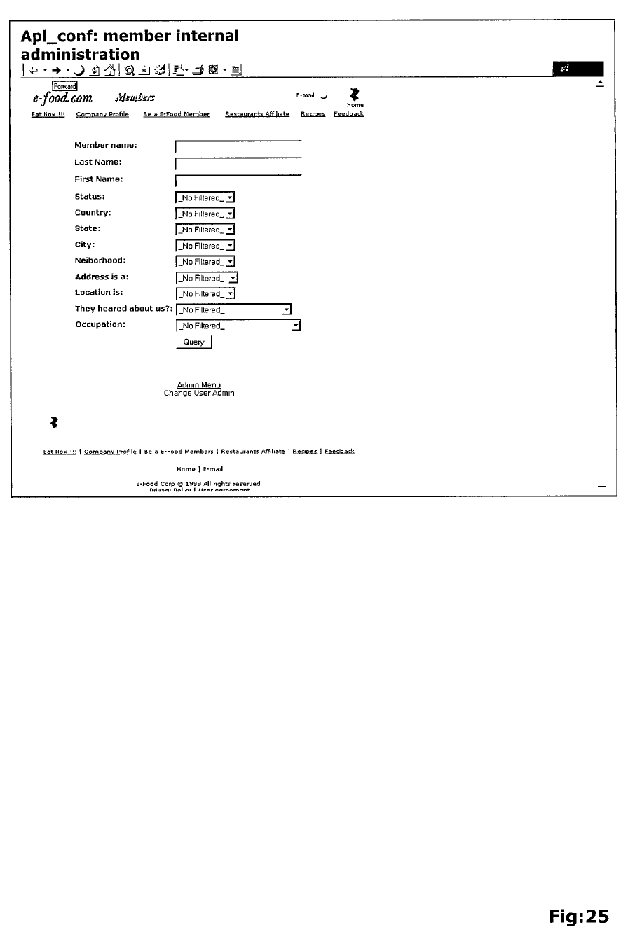

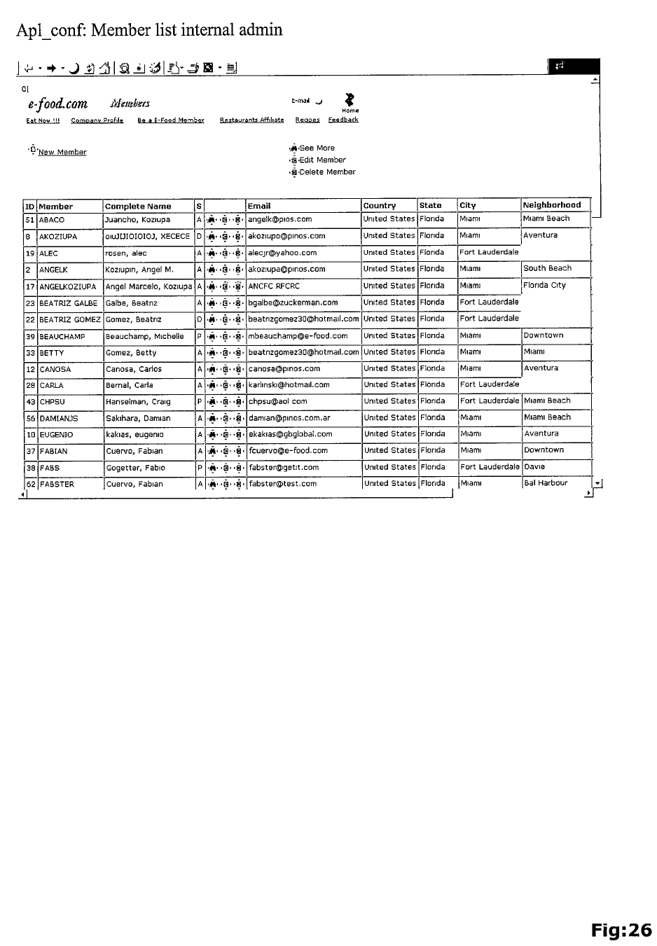

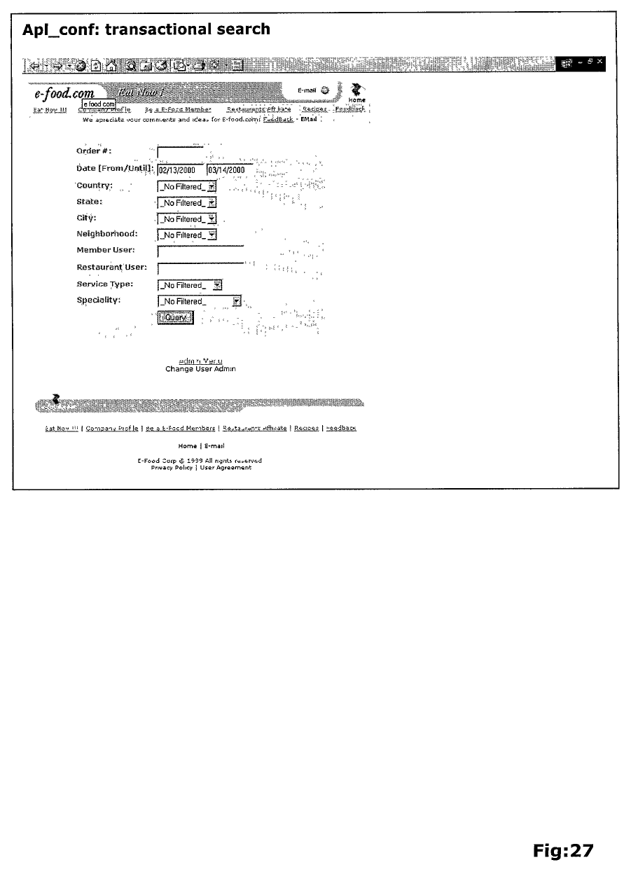

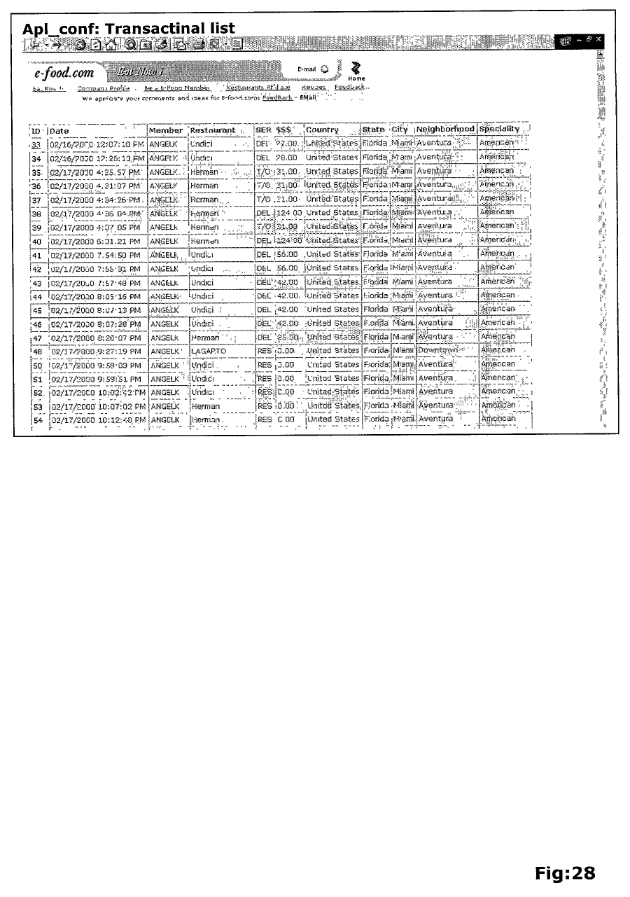

The software models will include four basic applications as shown in FIG. 2 (APL Members, APL Vendors, APL Trans, APL Conf). Any number of commercial available relational database management systems and a high level programming language that works with the database may be utilized to implement the invention. Skilled professionals in the art of programming application and database management will be able to make and use the invention according to the information related in this document.

5A.—Member and Vendor Application: According to a preferred embodiment of the invention, the APL Members will control the creation of new consumer profiles through the Internet and store that information in the member database. These profiles will include basic information related to the consumer location and may include name, telephone, address, country, state, city and neighborhood. The consumer can modify their own profile through a special authentication procedure such as a user id and password. See Exhibit A—Form: APL Members.

According to the invention, the APL Vendors will control the creation of new vendor profiles through the Internet and store that information in the vendor database. These profiles will include six sub profiles, including general information about the vendor, available vendor services, detailed information related to vendor operating hours and days, detailed information related to vendor delivery times and days, detailed information of the products and services offered by the vendor and detailed vendor billing information; The vendors can modify their own profile through a special authentication procedure such as a user id and password. See Exhibit B—Form: APL Vendors.

5B.—Transactional Process: When an authorized member elects to access current restaurants in a defined neighborhood area, the system will ask what kind of service they want to choose, from a variety of services available, such as take-out, delivery or advance reservations. Upon the desired selection, the application will display the different categories of restaurants that actually service the neighborhood that matches the member's neighborhood profile.

Upon the selection of the desired restaurant, the member can choose the different items that they want to order and have these items delivered to the address set in their profile or pick the items up themselves. The members will be asked what method of payment, from a variety of payment methods registered in the vendor profile, will be used in the purchase of the items. The application will send the order to the recipient registered in the vendor profile, using e-mail or fax or other communication such as a wireless message to a paging receiving device. See Exhibit C—Form: APL Trans.

According to a preferred embodiment, and as those of ordinary skill in the art will appreciate, a wireless paging system, such as commercially available from Skytel, Inc., of Mississippi, United States of America, can interface with an Internet web site to receive email messages from the web site system and convert these email messages to paging messages that can be wirelessly transmitted to paging receivers. These paging messages are delivered according to a reliable delivery method that assures delivery to the paging receivers by the paging system monitoring a confirmation message from the destination paging receiver. If the confirmation message is not received or received indicating a corrupted delivery, then the paging system will attempt to retransmit the paging messages to assure delivery.

The paging receivers typically display the message information to users of the paging receivers. Alternatively, the messages can be sent to a printing device that is communicatively coupled to the paging receiver for printing a hardcopy of the received messages.

For example, a recipient registered in the vendor profile may receive wirelessly transmitted messages from the application in the system, as discussed above. The paging receiver then presents the message information to a recipient user of the paging receiver. The recipient user then can read a display on the paging receiver to receive the message information, such as comprising an order information from a member as discussed above. Optionally, the paging receiver also prints a hardcopy record on paper via a printing device.

In one alternative preferred embodiment of the present invention, the recipient can send a confirmation message to the system. This can be done, for example, by manually pressing a button on the paging receiver. Alternatively, this confirmation can be configured at the paging receiver to be automatically replied to for all messages from the system. The confirmation message then provides an affirmative confirmation that a vendor has received an order request from a member and that the order will be acted upon. The system, in a preferred embodiment, may deliver an email message back to the member that originated the order request. Optionally, the system may make this information available as a displayed item on a web site page that the member can monitor to determine a status of their order. This confirmation mechanism provides the members with affirmative confirmation that their orders have been received and accepted by the vendors selected by the members. In this way, the members have affirmative feedback from the vendors that the orders have been accepted and are being acted upon. This positive confirmation is a significant advantage of the present invention that is not available in any prior art vending system.

As an alternative embodiment, the vendor may control the type of confirmation response that they provide back to the member to inform the member of varying status information. For example, the vendor may confirm that the order is accepted and will be promptly delivered to member according to the profile in the system. As another example, the vendor may confirm that the order is not accepted and that the member should seek other alternative vendor for placing an order. As a third example, the vendor may confirm that the order is accepted but the vendor schedule will be delayed by a specified time delay. The member, in this case, may be offered an opportunity to change or cancel their order with this vendor within a specified time limit because the vendor is not capable of meeting their profile for a delivery time according to the system. If the member changes or cancels their order, a second message is sent to the vendor to modify or to cancel the order being processed by the vendor's operations. This can be handled by the system in a very efficient and timely manner where the member and the vendor are minimally inconvenienced. Again, this timely order modification and cancellation feature is a very valuable advantage of the present invention that is not available in any known prior art systems.

5C.—Configuration: According to the invention, the APL Conf is oriented to make the configuration of the system to each different country in which the system is running. The access to this application will be granted only to the supervisor of the system with a special password and ID. The main sub application will be:

Edit/create/modify countries

Edit/create/modify members

Edit/create/modify vendors

Clear transactions

1. Edit/create/modify countries: This application defines new countries, and different states or provinces that are within a selected country, the different cities in a state/province, and the neighborhoods that are within the defined cities.

Each country will preferably be defined with its own type of currency, different kind of formal and credit card payment and information related to tax issues and price for each transaction assigned. This can be a fixed price per transaction or a % of a total cost of each transaction.

At the level of a country, a supervisor can create different kinds of categories for a particular country. For example, if the application will be directed toward restaurant services and delivery then the categories can be: ex. Italian, Japanese, American, deli, etc. If, for example, the application is directed toward a video rental service, then the categories can be: suspense, drama, and comedy, etc.

2/3 Edit/create/modify members & vendors: This application will be used to validate members and vendors. Each time that a new member or vendor creates a new entry on the system, the application will create a status pending in the database. With the status pending, a vendor or member can't appear like a validated member or vendor. This sub-application, can change this status with the purposes of making some kind of pre-validation for secure reasons and change the status to active.

With that validation, the vendor will receive a more validated and secure transaction on a wireless paging or an email system. Validated members are considered more reliable and trustworthy vendors in the system. A member at the time of using the system, such as for placing orders, will see validated vendors for taking orders. Pending vendors may advertise and communicate with members on the system but are more restricted with respect to conducting transactions with members.

4-Clear transactions: This sub application will be using for the supervisor to summarize all transactions in a segment of time in a select country, state, city and connecting to a merchant account system to begin to collect the revenues based on the information that the vendor have in the profile.

Upon the transaction being clear, a status clear will be fixed in the field of the transaction log.

An application conforming to the discussion above, and according to a preferred embodiment of the present invention, would be accessible through the World Wide Web using a URL.

The application has been described with reference to preferred embodiments particularly suited for a take out and delivery service, with menus stored in a database accessible to members. It's to be understood that the application, according to the invention, is suitable for other services, including the management of other kinds of services that may require a real time, or near real-time, response and delivery from vendors to consumers. Other kinds of services that can use and benefit from this invention may possibly be video club rentals, pharmacies and groceries, just to name a few kinds of vendors that sell goods and services to consumers, in which the time of the delivery makes a crucial differentiation between other vendor categories. Included below are the exemplary exhibits A, B, and C, that have been already referred to and discussed above. These exemplary exhibits are illustrated in tabular form below and may be visually presented to a user such as via a display screen, or via a series of display screens.

### EXHIBITS

Exhibit A - FORM: APL_MEMBERS:

| | |
|---|---|
| ● | This application is used for the consumers to create/modify they |
| | profile in the database. |

A-General information for Members:

```
(1). Access Information
  1. Member User:
  2. Member Password:
  3. Confirm password
(2) Member information
  1. Name:
  2. Last name:
  3. Country:
  4. State:
  5. City:
  6. Neighborhood:
  7. Address:
  8. Zip:
  9. Telephone:
10. Fax:
11. General E-Mail:
12. Gender:
13. Born Date or Age:
14. Additional Comments (optional)
```

Description: This form is used by the APL Members. Basically the member can create and Modify information about the profile that they have on the system. The information is stored in the Member Database.

Exhibit B - FORM: APL_VENDORS:
This application is used by the vendor to create/modify the
profile on the system.
B-General Information for Vendor:

(1). Access Information
1. Vendor User:
2. Vendor Password:
3. Confirm password:
(2) Vendor Store Information:
1. Vendor Store:
2. Manager (Complete Name):
3. Description Line of services:
4. Line 1 (optional)
5. Line 2 (optional)
Vendor Store: Is the name of the company that want to deliver or bring services.
Manager: Will be the name of the manager of the Store
Description: Will be the kind of services or products that the Store carry out.
Line 1/2: Are more detail information about the Store

(3) Location Information:

15. Country:
16. State:
17. City:
18. Neighborhoods:
19. Address:
20. Zip:
21. Telephone:
22. Fax:
23. General E-Mail:
24. Web site:
25. Additional Comments (optional)

This is all the information related to the store. It is important that the name (identification) of the neighborhood be provided.

B-Description of Product/Services Available

```
  1. Specialty of the Store:
  2. Level of the Store:
  3. Delivery:
  4. eCommerce:
  5. Reservations/Allocations:
  6. Take-out Products:
  7. Software Download:
  8. Only info:
  9. Picture:
10. Comments
Specialty: This will be a field with different options based on the configuration of category's based on country.
Level of the store: Is the level based on the services.
Delivery: If they offer delivery services.
Ecommerce: if the store will put goods to sell on the system.
```

Take-Out: If they offer take-out services.

Software: If they offer Download services of soft.

Only info: If the store only want carry out information

Picture: Up-load of the picture of the real store.

Comments: Additional comments

C-Delivery information (Smart Ecycles)

Days Open: - M - T - W - T - F - S - S

The Vendor can select the days of the week that the Store will be open to the consumers or members.

| | |
|---|---|
| Available [] Event A | From: HS:MM To HS:MM - Services |
| Available [] Event B | From: HS:MM To HS:MM - Services |
| Available [] Event C | From: HS:MM To HS:MM - Services |

The Vendor can define different events of delivery for a day and at what time begin and close this event.

The example will be Event A=Breakfast-Event B=Lunch-Event C=Dinner.

24 Hrs. Services[]
All Days Services[]

The vendor can defined that the store is open 24 hours or services all days.

● Delivery e-Mail:
● Delivery Fax:
● Delivery Phone:
● Delivery Clients:

E-mail: This will be a way in which the Vendor receives the order from the consumer.

If they select e-Mail, the vendor will receive the order in the Alphanumeric pager or via a direct connection of the computer vendor to the internet.

FAX: Using that option, the vendor will need to have a FAX machine 24 hs on the vendor store. The order will arrive to the number that the vendor registered on the system.

PAGE: Using this option, the vendor with a paging receiver can receive wirelessly transmitted messages from the system. The system, in one preferred embodiment, sends an email message to a paging system, such as from Skytel, Inc., and the paging system then wirelessly transmits the message information to the paging receiver associated with the vendor. Optionally, the paging receiver may be configured for confirmation messages that communicate back to the system and then back to a member that originated an order, such as via an email message or via a posting on a web page on a system web site.

Phone: This system allow to the vendor receive the information over the phone. The main application will translate the text to voice an will place a call to the telephone of the vendor.

Delivery Clients: The Main application will wait for a confirmation from the vendor for the order process. This option is normally for vendors that have a real time connection to the Internet. Optionally, this may be confirmed by vendors using a paging receiver with a confirmation feature enabled.

1. Minimums Order:
2. Especial Delivery Policies:
3. Payment method: Upon receive - Cash - Check - Credit Card
1. Will be the minimum order that the vendor accept to deliver.
2. The information regard the delivery policies. Will be a text field.
3. The different options that the vendor allow to pay.

D-Delivery SmartCycles

| | | | | | | | |
|---|---|---|---|---|---|---|---|
| TIME | M | T | W | T | F | S | S |

| | |
|---|---|
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |
| FROM:H: | TO H:M |
| M | |

This will be how many deliveries the vendor can make in a segment of time in a specific day.

This basically will protect the vendor to not accept more orders than they can deliver and protect the consumer from a delay in the delivery time.

(E) Products/Services for delivery

| | | | | | | | | | |
|---|---|---|---|---|---|---|---|---|---|
| CLASS | | | | | | | | | |
| 1 | | | | | | | | | |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CLASS | | | | | | | | | |
| 2 | | | | | | | | | |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CLASS | | | | | | | | | |
| 3 | | | | | | | | | |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |
| CODE | NAME | CATEGORY | DESCRIPTION | PICTURE | WEIGHT | STS | STMK | PRICE | $ DEL |

The vendor will manually enter the different information of the products or services that they carry out.

The screen will have different sections (CLASS) based on the category that the vendor selects.

Code: will be the code defined by the vendor

Name: Will be the name of the products/Service

Category: Will be the category for example: deliver/ecommerce

Description: Will be more information about the products/Services

Picture: Will be and optional picture of the products or services

Weight: will be the weight of the products.

STS: The viability of products/services

STMK: is the minimum stock daily that was put on the system.

Price: Will be the price of the product or service

$del: Additional cost for delivery?

(F) Payment information

1. Payment Method: (Credit Card-Cheq-Cash-E-money-Neocard-Wired
2. Acceptance of Agreement?

1. Will be the payment way that the vendor will clear the transaction to the company. If they select credit card the system will ask all the information related to the card and the bank that was the issuer.

2. This is the agreement that the vendor needs to accept transactions. Additional comment about Apl_vendors: all the information related this forms will be changed at any time by the vendor using the ID and password. All the information is stored in the Vendor database.

Exhibit C - FORM APL_TRANS:
This application is used to generate the transaction that comes from the
validate members/consumers and send the order of the product/services
requested to the vendor via e-mail or fax. This is the main application.
If the member/consumer is a validate user of the system, they will be
granted the access like a validate member. Later on, the system will be
asking your Neighborhood, if the member doesn't change will be appear
the default registered before.
User name & Password:?
What kind of service do you Want:?
Where area you now?
Phone:
Adress
Zip
State
City
Neighbor

When the member is validated for the system, will be asking what kind of services desired to begin to work with the application. The kind of services can be for example: Delivery/Commerce/Take-out and others available on the system.

The next options is in case that the member is outside of the actual neighborhood or is traveling outside and wants to deliver to another address. The member can change temporally the address and neighborhood and will be displayed information about the new parameters.

Categories
Search:
● 1-Category a (Total Found)
● 2-Category a (Total Found)
● 3-Category a (Total Found)
● 4-Category a (Total Found)
● 5-Category a (Total Found)
● 6-Category a (Total Found)
Select category:?

The member needs to select at this point, which is the category that they choose to begin to search through the active database of vendors in the neighborhood selected. The system will inform the different categories and the stores found in the database. Upon the selection, it will be appear on the screen the different stores.

ADVERTISEMENT

| | | | | | | | | |
|---|---|---|---|---|---|---|---|---|
| NAME: | RK | STS | PIC | INF | LVL | SER | RDY | MP |
| ADRESS | | | | | | | | |
| DESCRIPTION | | | | | | | | |
| NAME: | RK | STS | PIC | INF | LVL | SER | RDY | MP |
| ADRESS | | | | | | | | |
| DESCRIPTION | | | | | | | | |
| ON | | | | | | | | |
| NAME: | RK | STS | PIC | INF | LVL | SER | RDY | MP |
| ADRESS | | | | | | | | |
| DESCRIPTION | | | | | | | | |

In this sample screen, will appear the stores related to your neighborhood, based on the information of the member.

DESCRIPTION: Is the description of the store, basically the main activity in the category.

NAME: The name of the store.

ADRESS: The physical address of the vendor

DESCRIPTION2: Additional information about the vendor.

RK: Ranking by hits made at this vendor.

STS: The status of the store.

INF: Additional profile of the vendor.

PIC: The picture or photograph of the real store

LVL: The level of the store.

SER: The different services available.

RDY: If the store is open, Based on the local time of the computer member and the open time of the vendor

MP: Local maps for get into the real vendor store.

Upon the selection of the store, will appear the items available for buying/ordering by the member.

In this example, the system will show a restaurant that will be using the application to take orders for delivery.

Because the kind of service is delivery, the system doesn't necessarily show information such as weight or delivery price.

QTY

APPETIZERS

| 1 | CHICKEN/W | CHICKEN SPICE | 9$ | 1 |
|---|---|---|---|---|
| | | WINGS | | |
| 2 | NACHOS | BEST | 9$ | |
| | | MEXICAN APP | | |
| PLATES | | | | |
| 3 | HOT DOG | SAUSAGE | 14$ | |
| | | W/BREAD | | |
| 4 | HAMBURGER | AMERICAN | 13$ | 1 |
| | | BIGGEST | | |
| 5 | PEPSI | SODA | 2$ | |
| 6 | COKE | SODA | 2$ | 1 |

| | |
|---|---|
| SUGGESTION | Mustard please! |
| PAYMENT | CREDIT CARD/CHEQ/CASH |

In that example, the member selects on screen the options 1, 4 and 6. The system, will want from the member to confirm the order to begin to send the message to the address already registered at the profile of the vendor. This transaction will be stored in the transaction database, and will add a point to the vendor and the consumer for future exchanges of bonus or additional services.

While there has been illustrated and described what are presently considered to be the preferred embodiments of the present invention, it will be understood by those of ordinary skill in the art that various other modifications may be made, and equivalents may be substituted, without departing from the true scope of the present invention.

Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A system comprising:
at least one vendor communication device for at least receiving messages and presenting the messages to at least one vendor;
a computer system including:
a network interface for communicating messages via a network;
a vendor database including at least a collection of vendor records, each of the vendor records identifying a means of sending messages to at least one vendor communication device corresponding to each of the at least one vendor;
a controller, communicatively coupled to the network interface and to the vendor database, for receiving a customer order request including order information for an order of at least one of goods and services provided by at least one vendor having at least one vendor record in the vendor database, and, in response to receiving the customer order request, sending via the network interface at least one message to the at least one vendor communication device corresponding to at least one vendor according to the at least one vendor record corresponding to the at least one vendor, the at least one message including the order information for at least one of goods and services provided by the at least one vendor.

2. The system of claim 1, wherein the at least one vendor communication device comprises at least one of: a paging device, a two-way paging device, a facsimile device, a printing device, and a computing device.

3. The system of claim 1, wherein the at least one vendor record identifies a geographic area serviced by the at least one vendor, and wherein the controller sends the at least one message to the at least one vendor if the order information indicates an order of at least one of goods and services provided by the at least one vendor in the geographic area.

4. The system of claim 1, wherein the controller sends the at least one message for wireless transmission to the at least one vendor communication device.

5. The system of claim 1, wherein the computer system comprises a web site system and the network interface is communicatively coupled to the Internet.

6. The system of claim 1, wherein the computer system receives the customer order request via the network interface.

7. The system of claim 1, wherein the computer system receives a confirmation message from the at least one vendor communication device, the confirmation message corresponding to the at least one message including the order information for at least one of goods and services provided by the at least one vendor.

8. The system of claim 7, wherein the confirmation message indicates that the at least one vendor communication device has received the at least one message including the order information for at least one of goods and services provided by the at least one vendor.

9. The system of claim 7, wherein the confirmation message indicates that the at least one vendor has received the order information for at least one of goods and services provided by the at least one vendor.

10. The system of claim 7, wherein the confirmation message indicates that the at least one vendor has received the order information for at least one of goods and services provided by the at least one vendor, and wherein the controller provides confirmation information to a user that originated the customer order request to indicate to the user that the at least one vendor has received the order information.

11. The system of claim 7, wherein the confirmation message indicates that the at least one vendor has received the order information for at least one of goods and services provided by the at least one vendor and that the vendor is requesting at least one of
acceptance of the order,
a modification of the order information,
acceptance of the order with a specified delay in delivery time, and
non-acceptance of the order.

12. The system of claim 1, wherein the vendor database comprises a database of restauranteurs, and the order is for food provided by at least one restauranteur.

13. A method for an on-line order processing system, the method comprising the steps of:
receiving via a network interface a customer order request including order information for an order of at least one of goods and services provided by at least one vendor in a geographic area serviced by the at least one vendor, the at least one vendor being represented by at least one vendor record in a vendor database, the at least one vendor record identifying the geographic area;
determining from the order information and the vendor database a means of communicating with at least one vendor communication device of at least one vendor corresponding to the order; and
sending via a network interface at least one message to at least one vendor communication device according to the at least one vendor record corresponding to the at least one vendor, the at least one message including the order information for at least one of goods and services provided by the at least one vendor in the geographic area.

14. The method of claim 13, wherein the sending step comprises the step of wirelessly transmitting at least one message to the at least one vendor communication device.

15. The method of claim 13, wherein the vendor database comprises a database of restauranteurs, and the order is for food provided by at least one restauranteur.

16. The method of claim 13, further comprising the step of:
receiving a confirmation message from the at least one vendor communication device, the confirmation message corresponding to the at least one message including the order information for at least one of goods and services provided by the at least one vendor in the geographic area.

17. The method of claim 13, further comprising the step of:
receiving a confirmation message from the at least one vendor communication device, the confirmation message indicating that the at least one vendor has received the order information for at least one of goods and services provided by the at least one vendor in the geographic area.

18. The method of claim 13, further comprising the steps of:
receiving a confirmation message from the at least one vendor communication device, the confirmation message indicating that the at least one vendor has received the order information for at least one of goods and services provided by the at least one vendor in the geographic area and that the vendor is requesting at least one of
acceptance of the order,
a modification of the order information,
acceptance of the order with a specified delay in delivery time, and
non-acceptance of the order.

19. An on-line computer system comprising:
network interface communicatively coupled to the Internet;
order receiving means for receiving order requests from customer members via the network interface, the order requests including order information for orders of at least one of goods and services provided by at least one vendor in a geographic area serviced by the at least one vendor;
a vendor database including at least a collection of vendor records, each of the vendor records identifying a means of sending messages to at least one vendor communication device corresponding to each of the at least one vendor, and further each of the vendor records identifying a geographic service area serviced by each of the at least one vendor;
determining means, communicatively coupled to the order receiving means and the vendor database, for determining from the order information and the vendor database a means of communicating with at least one vendor communication device of at least one vendor corresponding to the order; and
sending means for sending via a network interface at least one message to at least one vendor communication device according to the at least one vendor record corresponding to the at least one vendor, the at least one message including the order information for at least one of goods and services provided by the at least one vendor in the geographic area.

20. The on-line computer system of claim 19, further comprising:
confirmation receiving means for receiving a confirmation message from the at least one vendor communication device, the confirmation message indicating that the at least one vendor has received the order information for at least one of goods and services provided by the at least one vendor in the geographic area.
